(19) United States
(12) Patent Application Publication
(10) Pub. No.: US 2021/0105164 A1
(43) Pub. Date: Apr. 8, 2021

(54) BASE STATION APPARATUS, TERMINAL APPARATUS, AND COMMUNICATION METHOD

(71) Applicants: SHARP KABUSHIKI KAISHA, Sakai City, Osaka (JP); FG Innovation Company Limited, Tuen Mun, New Territories (HK)

(72) Inventors: OSAMU NAKAMURA, Sakai City, Osaka (JP); TAKASHI YOSHIMOTO, Sakai City, Osaka (JP); JUNGO GOTO, Sakai City, Osaka (JP); YASUHIRO HAMAGUCHI, Sakai City, Osaka (JP)

(21) Appl. No.: 16/498,302

(22) PCT Filed: Mar. 27, 2018
(86) PCT No.: PCT/JP2018/012381

§ 371 Date: Sep. 26, 2019

(30) Foreign Application Priority Data
Mar. 31, 2017 (JP) 2017-070764

(51) Int. Cl. H04L 27/26; H04W 80/02; H04L 5/00; H04L 1/00

(52) U.S. Cl. CPC H04L 27/2613; H04W 80/02; H04L 5/0048; H04L 5/001; H04L 27/2636; H04L 1/0003; H04L 27/2607

(57) ABSTRACT

Depending on whether a transmission scheme is CP-OFDM or DFT-S-OFDM, the same MCS index that is notified is handled as different TBS indexes.

### TECHNICAL FIELD

The present invention relates to a base station apparatus, a terminal apparatus, and a communication method.

This application claims priority based on JP 2017-070764 filed on Mar. 31, 2017, the contents of which are incorporated herein by reference.

### BACKGROUND ART

The demand for high-speed wireless transmission has increased due to the popularity of smartphones, tablet terminals and the like in recent years. A standardization group, the Third Generation Partnership Project (3GPP), discusses New Radio (NR) as the fifth generation mobile communication system (5G). For NR, specifications have been made to satisfy the requirements of three use cases: enhanced Mobile Broadband (eMBB) for high-capacity communication with high frequency utilization efficiency; massive Machine Type Communication (mMTC) containing multiple terminals; and Ultra-Reliable and Low Latency Communication (URLLC), which realizes reliable and low latency communication.

For the Long Term Evolution (LTE) uplink, Discrete Fourier Transform Spread Orthogonal Frequency Division Multiplexing (DFT-S-OFDM) with low PAPR is employed. On the other hand, for NR, in addition to DFT-S-OFDM, it is agreed to employ OFDM (also referred to as CP-OFDM). Therefore, it can be assumed that a terminal apparatus that uses DFT-S-OFDM (also referred to as SC-FDMA) and a terminal apparatus that uses CP-OFDM coexist in the same cell.

Advantages of CP-OFDM include high resistance to multipath (delay wave) and good properties in Multiple Input Multiple Output (MIMO) transmission. Additionally, since the DFT-S-OFDM has a low PAPR of the transmission signal waveform, it is possible to increase the transmit power while maintaining the burden on the amplifier. As a result, the DFT-S-OFDM can increase coverage.

On the other hand, various access schemes are conceivable as a method in which multiple terminal apparatuses communicate with the same base station apparatus. The access schemes used in LTE include Frequency Division Multiple Access (FDMA), Time Division Multiple Access (TDMA), Space Division Multiple Access (SDMA), and the like. Note that SDMA is also referred to as Multi-User Multiple Input Multiple Output (MU-MIMO). In NR, both CP-OFDM and DFT-S-OFDM are supported so that it is considered that CP-OFDM and DFT-S-OFDM form SDMA, in other words, MU-MIMO (NPL 1).

### CITATION LIST

### Non Patent Literature

NPL 1: Huawei, HiSilicon, “Discussion on UL MU-MIMO between CP-OFDM and DFT-S-OFDM for NR” R1-1700409, January 2017.

### SUMMARY OF INVENTION

### Technical Problem

A base station apparatus supporting CP-OFDM and DFT-S-OFDM needs to estimate a channel between each terminal apparatus and a base station apparatus in order to demodulate data. In LTE uplink, OFDM symbols including only reference signals is prepared, and a channel estimation is performed. This is because, in a case of DFT-S-OFDM, assuming a configuration including a data subcarrier and a reference signal subcarrier in one OFDM symbol, PAPR increases and benefits of DFT-S-OFDM are impaired. However, in a case of CP-OFDM, rather than configuring one OFDM symbol only by reference signals, reference signals can be allocated discretely in the frequency direction, and data signals can be allocated on resource elements (subcarriers) where no reference signal is mapped, and it is also adopted to LTE and radio LAN. In other words, it is possible to vary a signal format between CP-OFDM and DFT-S-OFDM. Here, the resource element is a minimum unit of a resource to which a signal (modulation symbol) such as a reference signal, uplink data, or the like is mapped.

In the case that the DFT-S-OFDM and CP-OFDM signal formats are different from each other, the system can be operated without problems by independently configuring the systems or dividing the use frequencies. However, there are demerits such as inability of flexible switching between DFT-S-OFDM and CP-OFDM.

One aspect of the present invention has been made in view of the above-described problems, and an object of the aspect of the present invention is to provide a base station apparatus, a terminal apparatus, and a communication method thereof that enable wide coverage and high frequency reason efficiency in a case of using DFT-S-OFDM and CP-OFDM for uplink transmission.

### Solution to Problem

To address the above-mentioned drawbacks, each configuration of a base station and a terminal according to an aspect of the present invention is configured as follows.

(1) In order to solve the above-described problems, a terminal apparatus according to an aspect of the present invention is a terminal apparatus for communicating with a base station apparatus, the terminal apparatus including: a receiver configured to receive an MCS index and resource allocation information for uplink data transmission from the base station apparatus; an MCS configuration unit configured to configure, based on a modulation scheme and a TBS index associated with the MCS index and the resource allocation information, the modulation scheme and a coding rate of the uplink data; a transmission scheme configuration unit configured to configure a transmission scheme of either a first transmission scheme or a second transmission scheme; and a resource element mapping unit configured to map a reference signal and uplink data to an OFDM symbol, based on the transmission scheme, wherein the resource element mapping unit is configured to map the reference signal to form a first OFDM symbol including only the reference signal in a case that the first transmission scheme is configured, and maps the reference signal to form a second OFDM symbol including at least the reference signal and the uplink data in a case that the second transmission scheme is configured, and the MCS configuration unit identifies the TBS index associated with the MCS index, based on the transmission scheme, and configures a transport block size to which the uplink data is mapped, based on the TBS index and the resource allocation information.

(2) In the terminal apparatus according to an aspect of the present invention, the transmission scheme configuration unit includes a table for indicating an association between the MCS index and the TBS index for each transmission scheme of the first transmission scheme and the second transmission scheme, and the MCS configuration unit identifies the TBS index, based on the table selected by the transmission scheme configured by the transmission scheme configuration unit.

(3) In the terminal apparatus according to an aspect of the present invention, the OFDM symbol includes a plurality of resource elements, a resource element of the plurality of resource elements is a minimum unit of a resource to which the reference signal and the uplink data are mapped, and a spacing between two resource elements to which the reference signal is mapped in the first OFDM symbol is the same as the spacing between two resource elements to which the reference signal is mapped in the second OFDM symbol.

(4) In order to solve the above-described problem, in the terminal apparatus according to an aspect of the present invention, the first OFDM symbol includes a plurality of resource elements, a resource element of the plurality of resource elements is a minimum unit of a resource to which the reference signal and the uplink data are mapped, and the first OFDM symbol includes the reference signal in all frequencies allocated according to the resource allocation information.

(5) In the terminal apparatus according to an aspect of the present invention, the reference signal allocated to the first OFDM symbol is orthogonal to the reference signal allocated to the second OFDM symbol in the same resource element to which the reference signal is allocated.

(6) In the terminal apparatus according to an aspect of the present invention, the first transmission scheme is DFT-S-OFDM, and the second transmission scheme is OFDM.

(7) A communication method for a terminal apparatus according to an aspect of the present invention is a communication method for a terminal apparatus for communicating with a base station apparatus, the communication method including: a reception step of receiving an MCS index and resource allocation information for uplink data transmission from the base station apparatus; an MCS configuration step of configuring, based on a modulation scheme and a TBS index associated with the MCS index and the resource allocation information, the modulation scheme and a coding rate of the uplink data; a transmission scheme configuration step of configuring a transmission scheme of either a first transmission scheme or a second transmission scheme; and a resource element mapping step of mapping a reference signal and uplink data to an OFDM symbol, based on the transmission scheme, wherein the resource element mapping step maps the reference signal to form a first OFDM symbol including only the reference signal in a case that the first transmission scheme is configured, and maps the reference signal to form a second OFDM symbol including at least the reference signal and the uplink data in a case that the second transmission scheme is configured, and the MCS configuration unit identifies the TBS index associated with the MCS index, based on the transmission scheme, and configures a transport block size to which the uplink data is mapped, based on the TBS index and the resource allocation information.

### Advantageous Effects of Invention

According to one or more aspects of the present invention, efficient transmission can be performed in a case that there are DFT-S-OFDM and CP-OFDM as transmission schemes (signal waveforms).

### BRIEF DESCRIPTION OF DRAWINGS

FIG. 1 is a schematic block diagram illustrating a configuration of a radio communication system according to the present embodiment.

FIG. 2 is a diagram illustrating a configuration example of a transmitter of a terminal apparatus according to the present embodiment.

FIG. 3 is a diagram illustrating an example of a subframe structure of DFT-S-OFDM according to the present embodiment.

FIG. 4 is a diagram illustrating an example of the subframe structure of DFT-S-OFDM according to the present embodiment.

FIG. 5 is a diagram illustrating an MCS table according to a conventional method.

FIG. 6 is a diagram illustrating an MCS table according to the present embodiment.

FIG. 7 is a diagram illustrating a configuration example of a receiver of a base station apparatus according to the present embodiment.

FIG. 8 is a diagram illustrating an example of a subframe structure of DFT-S-OFDM according to the present embodiment.

FIG. 9 is a diagram illustrating an example of a reference signal sequence of DFT-S-OFDM and CP-OFDM according to the present embodiment.

FIG. 10 is a diagram illustrating an example of a subframe structure of DFT-S-OFDM according to the present embodiment.

### DESCRIPTION OF EMBODIMENTS

The terminal apparatus collectively refers to a mobile or fixed user end apparatus such as a User Equipment (UE), a Mobile Station (MS), a Mobile Terminal (MT), a mobile station apparatus, a mobile terminal, a subscriber unit, a subscriber station, a wireless terminal, a mobile apparatus, a node, an apparatus, a remote station, a remote terminal, a wireless communication apparatus, a wireless communication apparatus, a user agent, an access terminal. The base station apparatus collectively refers to any node at a network end in communication with a terminal, such as a node B (NodeB), an enhanced node B (eNodeB), a base station, and an Access Point (AP). Note that the base station apparatus includes a Remote Radio Head (RRH, an apparatus having a smaller outdoor type radio unit than a base station apparatus, Remote Radio Unit: also referred to as RRU) (also referred to as a remote antenna or a distributed antenna). The RRH can also be said to be a special form of a base station apparatus. For example, the RRH may be referred to as a base station apparatus that includes only a signal processing unit, and is configured to configure parameters used by other base station apparatuses, and determine scheduling in an RRH, and the like.

Embodiments of the present invention will be described below in detail with reference to the drawings.

### First Embodiment

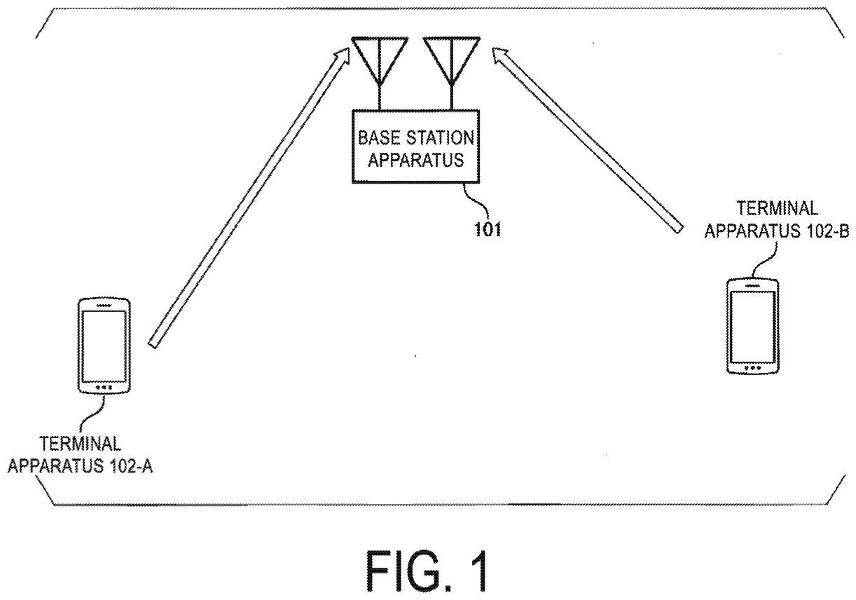

FIG. 1 is a schematic block diagram illustrating a configuration of a radio communication system according to the present embodiment. The system includes a base station apparatus 101, a terminal apparatus 102-A, and a terminal apparatus 102-B. In FIG. 1, the terminal apparatus 102-A performs transmission using a transmission scheme (signal waveform, waveform) with a low PAPR such as DFT-S-OFDM (SC-FDMA), and the terminal apparatus 102-B performs transmission using a transmission scheme with a high PAPR such as OFDM (CP-OFDM). The terminal apparatus 102-A is notified to use DFT-S-OFDM by Downlink Control Information (DCI) from the base station apparatus 101 or signaling of a higher layer such as RRC. On the other hand, the terminal apparatus 102-B is notified to use CP-OFDM by DCI from the base station apparatus 101 or signaling of a higher layer such as RRC. Note that the terminal apparatuses 102-A and 102-B may include both DFT-S-OFDM and CP-OFDM and may select one by control information or signaling, or may be fixed for each terminal apparatus.

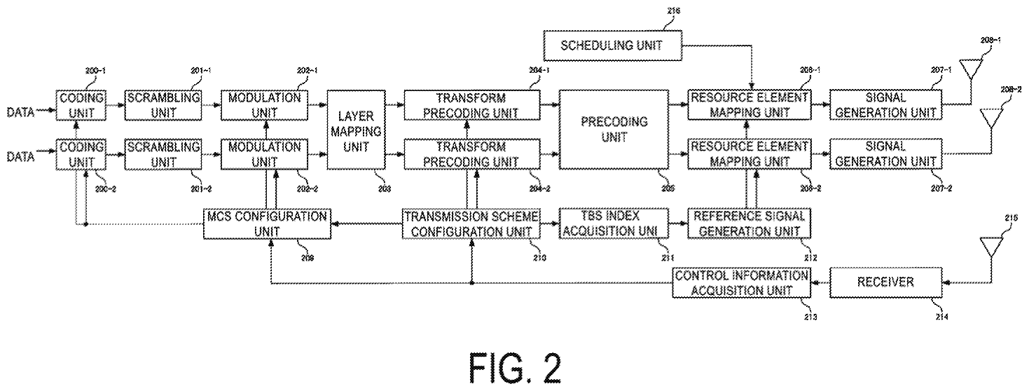

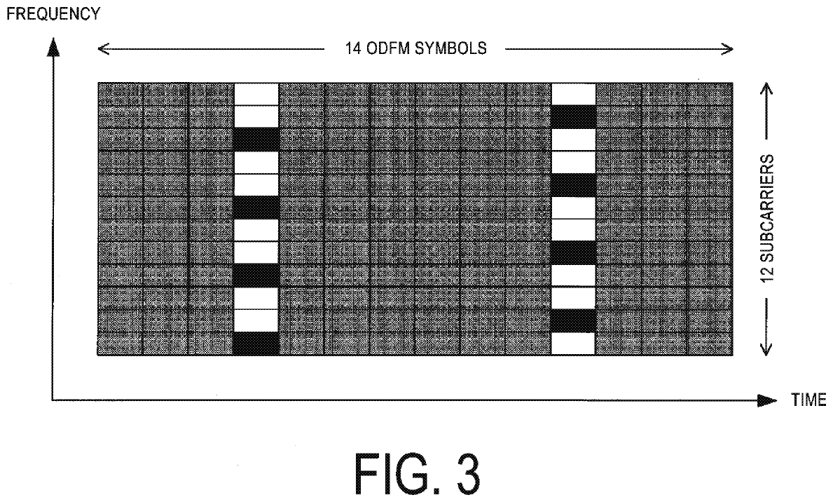

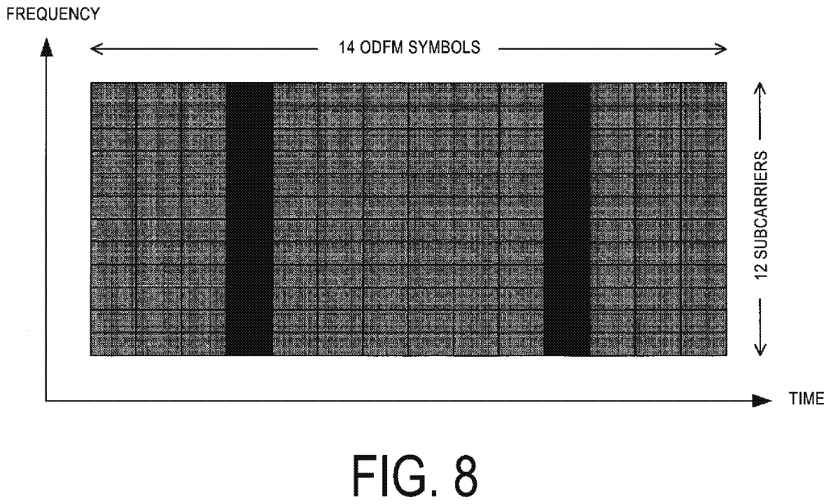

FIG. 2 is a diagram illustrating a configuration example of a transmitter of the terminal apparatuses 102-A and 102-B according to the present embodiment. Note that in FIG. 2, only the blocks (processing units) necessary for the description of the embodiment of the present invention are illustrated. Note that the terminal apparatuses 102-A and 102-B in FIG. 2 receive downlink signals (downlink control information, RRC signaling, data signals, and the like) transmitted by the base station apparatus 101 via a receive antenna 215 by a receiver 214. Among the downlink signals received by the receiver 214, downlink control information and RRC signaling are input to a control information acquisition unit 213. The input control information includes at least an MCS index and uplink resource allocation information (uplink grant, scheduling information). Note that the number of antenna ports configured for each terminal apparatus may be one or multiple. Here, the antenna port refers to a logical antenna that can be recognized by an apparatus that performs communication, rather than a physical antenna. In a case that multiple antenna ports are provided, existing techniques such as Single User MIMO (SU-MIMO) and transmit diversity may be applied. The terminal apparatus can notify the base station apparatus of UE Capability. The terminal apparatus may notify of a supported transmission scheme (DFT-S-OFDM, or/and OFDM) as the UE Capability. The terminal apparatus may notify the base station apparatus of a configuration of DMRS that can be used for data transmission of DFT-S-OFDM as the UE Capability. For example, the UE Capability includes information such as supporting either one of a configuration in FIG. 3 or a configuration of in FIG. 8, or supporting both the configuration of FIG. 3 and the configurations of FIG. 8.

The data of the terminal apparatus 102-A is coded at a coding unit 200-1 and a coding unit 200-2. Here, the coding rate is configured based on a coding rate notified by an MCS configuration unit 209. Note that the coding rate is determined by the MCS configuration unit 209, based on the MCS index notified by the control information acquisition unit 213. The coded bit sequence (codeword) obtained by coding the data of the terminal apparatus 102-A is input to a scrambling unit 201-1 and a scrambling unit 201-2. Here, in a case that the number of codewords is one, nothing is input to the scrambling unit 201-2. The number of codewords may be 3 or greater, and in this case, the same number of scrambling units as the number of codewords are prepared. For the scrambling unit 201-1 and the scrambling unit 201-2, terminal apparatus specific and coatword specific scrambling is applied. The outputs of the scrambling unit 201-1 to 201-2 are input to modulation units 202-1 to 202-2, respectively. In the modulation units 202-1 to 202-2, processing is performed to convert the input bit sequence to a modulation symbol (QPSK modulation symbol, QAM modulation symbol) such as QPSK or 64QAM. Here, the modulation scheme is configured based on the modulation scheme notified from the MCS configuration unit 209. Note that the modulation scheme is determined by the MCS configuration unit 209, based on the MCS index notified by the control information acquisition unit 213.

The outputs of the modulation units 202-1 to 202-2 are input to a layer mapping unit 203. In the layer mapping unit 203, in a case that the terminal apparatus 102-A performs transmission using multiple layers, a process is applied in which one or multiple codewords are allocated to each layer. In the following description, the number of layers is described as two, but any number may be used as long as the number of layers is a natural number. The output of the layer mapping unit 203 is input to transform precoding units 204-1 and 204-2.

In the transform precoding units 204-1 and 204-2, transform by Discrete Fourier Transform (DFT) is performed on the modulation symbol sequence input from the layer mapping unit 203. Here, a transmission scheme configuration unit 210 notifies whether or not to apply DFT. In a case of applying DFT, signals are transmitted using DFT-S-OFDM. In a case of not applying DFT, signals are transmitted using CP-OFDM. The transmission scheme configuration unit 210 acquires the transmission scheme (signal waveform) from the control information acquisition unit 213 explicitly or implicitly by RRC or DCI. The outputs of the transform precoding units 204-1 and 204-2 are input to a precoding unit 205

In the precoding unit 205, precoding is performed to transmit each layer from multiple antenna ports. Here, different precoding may be applied depending on whether or not the processing in the transform precoding units 204-1 and 204-2, specifically DFT, is applied (or whether or not the transmission scheme is with a high Peak to Average Power Ratio (PAPR)). Description is given with reference to FIG. 2 in which the number of transmit antennas (the number of antenna ports) is two, but any number may be used as long as the number is a natural number greater than or equal to the number of layers. The output of the precoding unit 205 is input to resource element mapping units 206-1 and 206-2. In the resource element mapping units 206-1 and 206-2, the signal input from the precoding unit 205 is allocated to any radio resource (resource element, subcarrier) (resource allocation is performed). Which resource element is to be used is determined by the input from a scheduling unit 216. The scheduling unit 216 performs resource allocation, based on the resource allocation information (e.g., the number of resource blocks to allocate the data) for the uplink data included in the downlink control information or/and the configuration information acquired by the control information acquisition unit 213, the allocation information of the reference signal, and the like. In the resource mapping units 206-1 and 206-2, the processing of allocating reference signals (DeModulation-Reference Signal (DM-RS) or the like) input from the reference signal generation unit 212 to prescribed resource elements is also performed. The DM-RS is a reference signal that is used in demodulating data. Here, the reference signal generation unit 212 generates a reference signal, based on information related to the transmission scheme notified by the transmission scheme configuration unit 210. The details will be described later, however, for example, in a case that the information related to the transmission scheme is DFT-S-OFDM, the reference signal generation unit 212 generates OFDM symbols only including OFDM symbols for reference signals, or reference signals, not including data signals. On the other hand, in the case of CP-OFDM, the reference signal generation unit 212 generates OFDM symbols including at least an uplink data signal and reference signal. Note that the above is an example, and in a case that the generation method of OFDM symbols including reference signals is different depending on information related to the transmission scheme notified by the transmission scheme configuration unit 210, it is included in one aspect of the present invention.

The outputs of the resource element mapping units 206-1 and 206-2 are input to signal generation units 207-1 and 207-2, respectively. In the signal generation units 207-1 and 207-2, Inverse Fast Fourier Transform (IFFT) is applied to the inputs from the resource element mapping units 206-1 and 206-2, and Cyclic Prefix (CP) is added. Furthermore, processing such as D/A conversion, transmit power control, filtering, up-conversion, and the like are applied. The outputs of the signal generation units 207-1 and 207-2 are transmitted from antennas 208-1 and 208-2. Here, whether to use CP-OFDM or DFT-S-OFDM may be uniquely configured for each terminal apparatus by RRC or DCI.

Next, a radio frame (subframe, slot, minislot) configuration performed by the resource element mapping units 206-1 and 206-2 will be described. FIG. 3 describes a resource block in the case of using DFT-S-OFDM. In FIG. 3, the fourth and 11th OFDM symbols are OFDM symbols for reference signals. Hereinafter, it is assumed that 14 OFDM symbols constitutes a single subframe and that allocations are performed for each subframe, but the present invention is not limited thereto, and radio resource allocation may be performed in slot (seven OFDM symbols) units or minislot (four OFDM symbols, for example) units. However, the allocation of reference signals is not limited thereto, and a reference signal symbol may be allocated at the beginning of the subframe. The position or number of OFDM symbols including reference signals may be notified from the base station apparatus to the terminal apparatus with control information (RRC, DCI, or the like). In this case, the terminal apparatus multiplexes a reference signal to an OFDM symbol based on received control information. In the drawing, black-filled portions indicate resource elements (RE) including a reference signal, and the white space indicates null subcarriers (RE not including data or reference signal), and the shading indicates data signals. In FIG. 3, the subcarrier spacing (frequency spacing) of the resource elements on which reference signals are allocated is the same as the fourth and the 11th, but may be allocated with different spacing. The positions of the subcarriers of the resource elements on which reference signals are allocated are different at fourth and 11th in the frequency direction, but may be the same. Note that the frequency spacing of the resource elements on which the subcarriers are allocated and the positions of the subcarriers may be notified from the base station apparatus by RRC, DCI, or the like.

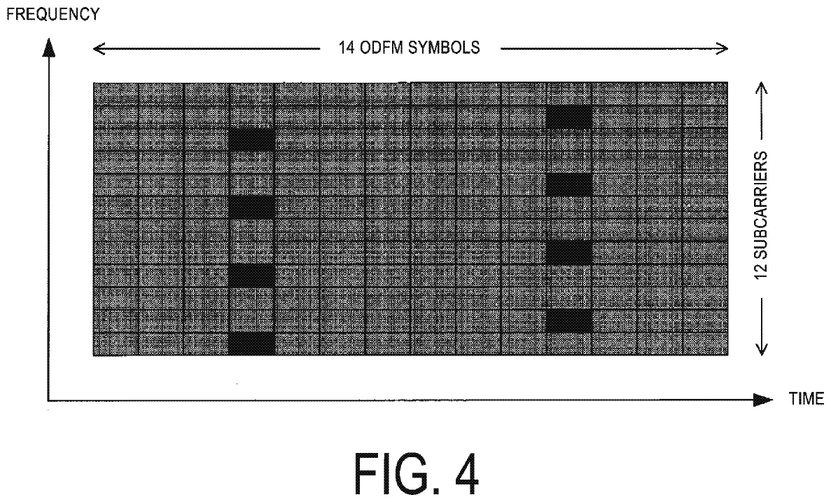

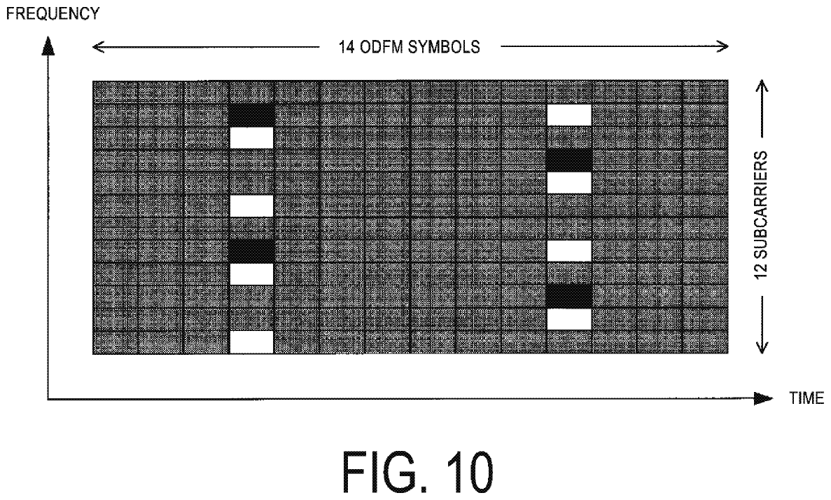

Next, a resource block in the case of using CP-OFDM will be described with reference to FIG. 4. In FIG. 4, reference signals are included in the fourth and 11th OFDM symbols same as in FIG. 3, but unlike FIG. 3, data signals are present in OFDM signals including reference signals without using null subcarriers. In order to avoid deterioration of PAPR in DFT-S-OFDM, it is preferable that data and reference signals be transmitted by OFDM symbols that are different from each other, but there is no problem even in a case that data signals and the reference signals are included in the same OFDM symbols since data signal in CP-OFDM has a high PAPR. Thus, in the case of using CP-OFDM, it can be filled with data signals instead of using null carriers. Note that the configuration of the reference signals is not limited to that of FIG. 3, and as illustrated in FIG. 10, rather than OFDM symbols for reference signals including only reference signals and data signals, null carriers may be included, and the number of null carriers included in one OFDM symbol and the number of subcarriers of the data signals may be different.

As described above, the configuration of the reference signals can be changed between CP-OFDM and DFT-S-OFDM. As a result, the number of pieces of data included in one subframe is different in CP-OFDM and DFT-S-OFDM. For example, in the case of FIG. 3, DFT-S-OFDM includes 12 OFDM symbols×12 subcarriers, i.e., 144 resource elements in one resource block. On the other hand, in the case of CP-OFDM in FIG. 4, 8 REs for data allocation are present in each OFDM symbol in which reference signals are allocated, and thus 160 REs can be transmitted in one resource block, having 16 more REs compared to DFT-S-OFDM.

The communication system of the present embodiment may apply Adaptive Modulation and Coding, Link Adaptation. Specifically, in the MCS configuration unit 209, the number of information bits transmitted in one transport block is determined by the number of resource blocks used for the communication and the MCS index (or TBS index) (3GPP TS36.213 Table 7.1.7.2.1-1, for example). The TBS Index is an index associated with the number of resource blocks and indicating the number of information bits per resource block number. For example, it is assumed that TBS index 0 indicates the number of information bits as 16 in the resource blocks number 1. In a case that the MCS index is the lowest number 0 (the modulation order is 2, and the TBS index is 0) and the number of resource blocks used is 1, 16 bits of information bits will be included in the transport block.

As described above, in the case of DFT-S-OFDM, 144 REs per subframe are used for transmission. In a case that the MCS index is 0, QPSK is used, so 288 bits can be transmitted as coded bits per subframe. In a case that the 16 bits of information bits described above are transmitted with 288 bits of coded bits, the coding rate is 0.056. On the other hand, in the case of CP-OFDM, 160 REs per subframe is used for transmission. In a case that the MCS index is 0, QPSK is used, so 320 bits can be transmitted as coded bits per subframe. In a case that the 16 bits of information bits described above are transmitted with 320 bits of coded bits, the coding rate is 0.050. In other words, even in a case that the same MCS index is used for CP-OFDM and DFT-S-OFDM, the coding rates will vary. Motivation for introducing DFT-S-OFDM is to ensure wide coverage but transmission at higher coding rates than CP-OFDM is also achieved. In other words, CP-OFDM transmits at a low power with a low coding rate, and DFT-S-OFDM transmits at a high power transmit power with a high coding rate.

In this manner, even though DFT-S-OFDM is introduced assuming that the terminal apparatus at the cell edge transmits at a low rate, in a case that the same MCS index is used, DFT-S-OFDM has a higher coding rate than CP-OFDM and performs an error-prone communication. Therefore, in the communication system of the present embodiment, DFT-S-OFDM is configured to perform more reliable transmission even with the same MCS index.

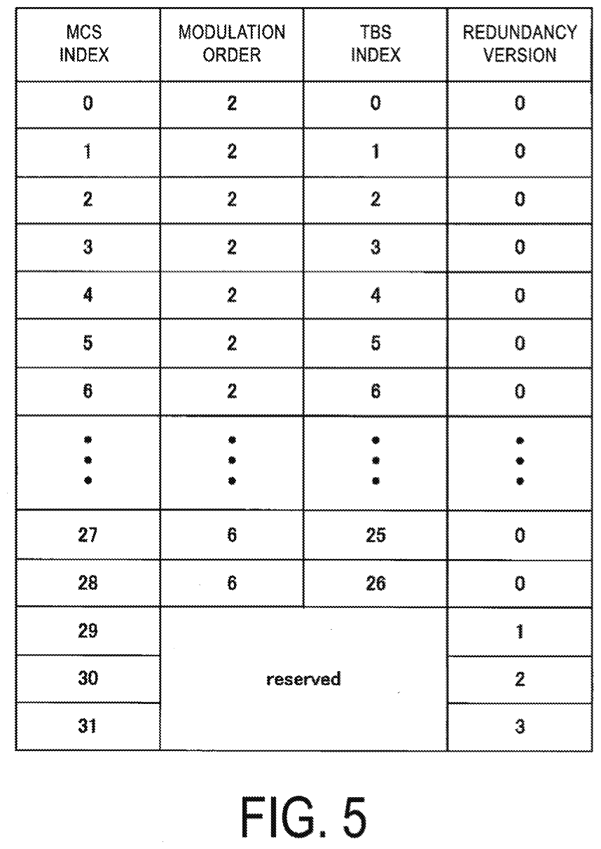

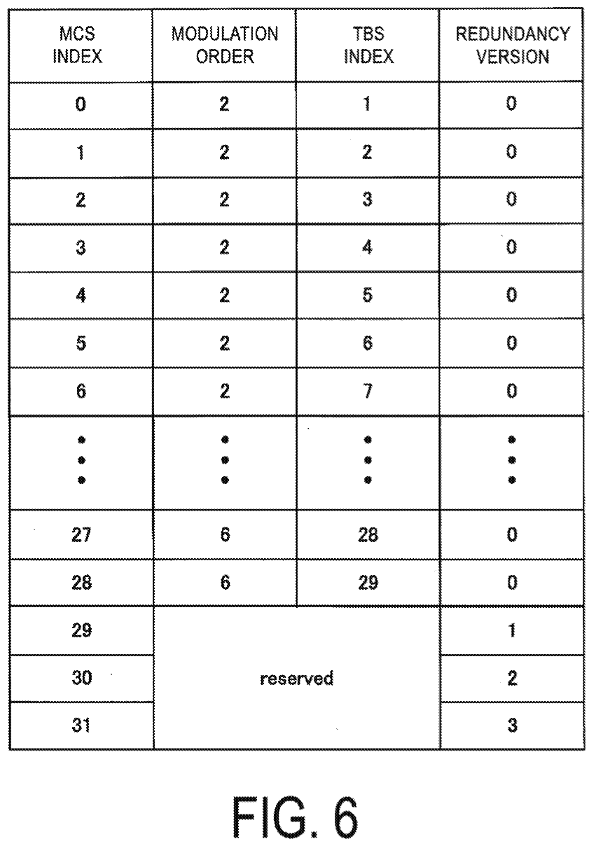

One method by which DFT-S-OFDM supports the lowest coding rate (transmission rate, spectral efficiency) is considered to change the MCS table used in the MCS configuration unit 209, depending on whether the transmission scheme used is CP-OFDM or DFT-S-OFDM. For example, the MCS table illustrated in FIG. 5 is used. In a case that the MCS index is 0, the TBS index is 0. In a case that the TBS indices are the same for DFT-S-OFDM and CP-OFDM, DFT-S-OFDM will have a higher coding rate as described above. Then, different MCS tables are used in DFT-S-OFDM and CP-OFDM. For example, in a case that the transmission scheme configuration unit 210 configures DFT-S-OFDM in accordance with a notification by a higher layer or DCI, the TBS index acquisition unit 211 uses the MCS table illustrated in FIG. 5. On the other hand, in a case that the transmission scheme configuration unit 210 is configured to use CP-OFDM, the TBS index acquisition unit 211 uses the MCS table in FIG. 6. In the MCS table illustrated in FIG. 6, even in a case that the MCS index is 0, the TBS index is 1 instead of 0. As a result, even in a case that the MCS index is the same, the number of information bits that can be transmitted is higher in CP-OFDM. This allows DFT-S-OFDM to realize a low rate transmission, and allows CP-OFDM to realize communication at a high transmission rate in a case that a high MCS index is used. Note that in the present embodiment, different MCS tables are configured for each of CP-OFDM and DFT-S-OFDM, but this is not a limitation, and in the case of CP-OFDM, the MCS index may be incremented by one to calculate the TBS index. The table of TBS index and TBS size may be expanded to include the TBS index increased by addition of the MCS table in FIG. 6, or a mechanism may be incorporated for the TBS index value to be adjusted so that the TBS index value does not exceed the TBS table configured value.

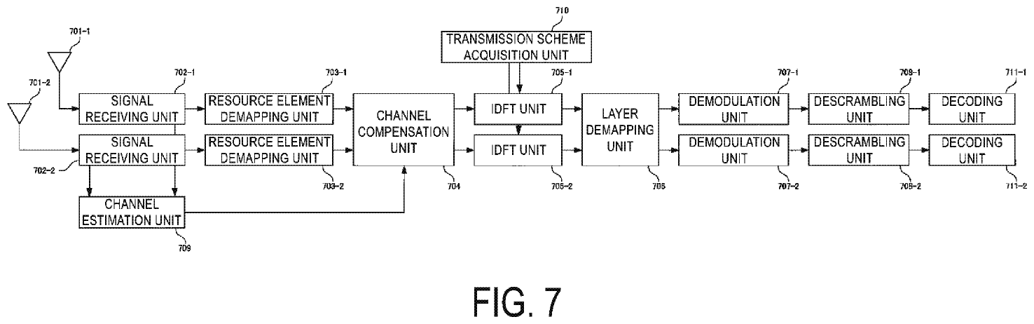

FIG. 7 is a diagram illustrating an example configuration of a receiver of a base station 101 apparatus according to the present embodiment. Signals transmitted by the terminal apparatus 102-A and the terminal apparatus 102-B are received by a receive antenna 701-1 and a receive antenna 701-2. Here, a description is given in which the number of s is two, but there may be one receive antenna or three or more receive antennas. For signals received at the receive antenna, in a signal receiving unit 702-1 and a signal receiving unit 702-2, a down-conversion, A/D conversion, CP removal, FFT application, or the like is performed. Here, demodulation of the terminal apparatus 102-A is described, but in a case of demodulation of the terminal apparatus 102-B, FFT is performed depending of the number of IFFT points used by the transmitter of the terminal apparatus 102-B. A signal including an A/D converted reference signal is input to a channel estimation unit 709. The output of the signal receiving unit 702-1 and the signal receiving unit 702-2 are input to a resource element demapping unit 703-1 and a resource element demapping unit 703-2, respectively. In the resource element demapping units 703-1 and 703-2, the resource elements used for communication with the terminal apparatus 102-A are extracted by the scheduling information input from a scheduling unit (not illustrated) notified by a transmission scheme acquisition unit 710. The outputs of the resource element demapping units 703-1 and 703-2 are input to a channel compensation unit 704. In the channel compensation unit 704, a process that compensates for the effects of the channel is applied. In a case that there are multiple receive antennas, only signals addressed to the terminal apparatus 102-A are detected by applying spatial filtering or MLD in the channel compensation unit 704. The output of the channel compensation unit 704 is input to an IDFT unit 705-1 and an IDFT unit 705-2. In the present embodiment, a description is given in which the number of layers is two, but the number may be one or three or greater. In the IDFT unit 705-1 and the IDFT unit 705-2, whether IDFT is applied or not is determined by information related to the transmission scheme notified by the transmission scheme acquisition unit 710. In a case that it is notified that DFT-S-OFDM is used from the transmission scheme acquisition unit 710, conversion from a frequency domain signal to a time domain signal is performed by IDFT, and in a case that it is notified that CP-OFDM is used, IDFT is not applied. Note that the present invention is not limited to IDFT, and inverse conversion of the conversion in the transform precoding units 204-1 and 204-2 in FIG. 2 is performed. Whether or not IDFT is applied can be determined for each layer. The outputs of the IDFT unit 705-1 and the IDFT unit 705-2 are input to a layer demapping unit 706. In the layer demapping unit 706, in a case that the signal transmitted by the terminal apparatus 102-A includes multiple layers (streams), the conversion to codeword is performed. The output of the layer demapping unit 706 is input to a demodulation unit 707-1 and a demodulation unit 707-2. In the demodulation unit 707-1 and the demodulation unit 707-2, processing is performed to calculate Log Likelihood Ratio (LLR) of the bit sequence from the input received signal sequence. Bit LLR sequences output by the demodulation unit 707-1 and the demodulation unit 707-2 are input to a descrambling unit 708-1 and a descrambling unit 708-2. In the descrambling unit 708-1 and the descrambling unit 708-2, the terminal apparatus specific scrambling is released. The coded bit sequence output by the descrambling unit descrambling unit 708-1 and the descrambling unit 708-2 is applied processing such as decoding in the reception apparatus. Note that, although not illustrated, the base station apparatus 101 in FIG. 7 includes a transmitter configured to generate and transmit a downlink signal to the terminal apparatuses 102-A and 102-B. The downlink signal includes configuration information (RRC signaling) and control information (downlink control information) for the uplink signal transmitted by the terminal apparatus. At this time, an MCS table is provided for each uplink transmission scheme, and an MCS index is determined based on each table and is notified to the terminal apparatus as downlink control information or configuration information. Note that multiple tables need not necessarily be present, and association of TBS index and MCS index may be different depending on the transmission scheme.

As described above, according to the present embodiment, the MCS table is changed so that DFT-S-OFDM is responsible for the lowest coding rate rather than CP-OFDM in a case that the number of resource elements that can be used for data transmission differs. The MCS table may also be changed so that CP-OFDM is responsible for a higher transmission rate than DFT-S-OFDM. That is, depending on whether a transmission scheme is CP-OFDM or DFT-S-OFDM, the same MCS index that is notified is handled as different TBS indexes. As a result, high frequency utilization efficiency due to CP-OFDM can be achieved while ensuring a wide coverage.

### Second Embodiment

The present embodiment is an example of a method for suppressing large interference to CP-OFDM while keeping the transmit power of OFDM symbols for reference signals of DFT-S-OFDM identical to that of OFDM symbols for data signals. In the present embodiment, CP-OFDM is configured to transmit data signals by OFDM symbols including reference signals as in FIG. 4, while DFT-S-OFDM transmits reference signals on all subcarriers rather than using null carriers by OFDM symbols including reference signals as in FIG. 3. FIG. 8 is an example of allocating reference signals on all subcarriers in OFDM symbols (SC-FDMA symbols) for reference signals. As a result, in a case that the power of OFDM symbols is constant, DFT-S-OFDM can achieve the same spectral density as CP-OFDM, and thus interference with CP-OFDM can be suppressed. Compared to a case that reference signals are discretely allocated, the power of OFDM symbols is higher, so the channel estimation with high accuracy can be performed.

In this case, there is a problem in that the reference signal of a portion of the reference signal symbol of DFT-S-OFDM collides with the data signal included in the same OFDM symbol as the reference signal in the case of CP-OFDM. Thus, first, channel estimation is performed using the reference signal of DFT-S-OFDM transmitted in the same RE as the reference signal of CP-OFDM. That is, at this stage, a portion of the reference signal of DFT-S-OFDM is used for channel estimation. Using estimated values of CP-OFDM and DFT-S-OFDM, signal detection such as spatial filtering and MLD is applied. Next, in a case that signal detection is applied to the OFDM symbol including the reference signal, CP-OFDM can detect data. By canceling the data signal of CP-OFDM detected through signal detection from the received signal, only DFT-S-OFDM receive reference signal may be extracted. CP-OFDM can perform channel estimation with high accuracy by performing channel estimation of DFT-S-OFDM for the signal in which data signal is canceled. In a case that the channel estimation accuracy of DFT-S-OFDM is improved, the DFT-S-OFDM data signal can be estimated correctly. By canceling the resulting high-accuracy channel estimation result and the data signal of DFT-S-OFDM included except in the OFDM symbol including the reference signal from the received signal, it is possible to improve the signal detection accuracy of CP-OFDM. In this way, signal detection accuracy can be improved by repeating signal detection and cancellation.

### Third Embodiment

In the second embodiment, an example has been described in which, in the case of using CP-OFDM, OFDM symbols including at least a reference signal and a data signal are formed, and in the case of using DFT-S-OFDM, OFDM symbols for transmitting reference signals in the entire usage band are formed. In this case, the sequence lengths of the reference signals differ between CP-OFDM and DFT-S-OFDM. In this case as well, it is necessary to separate the reference signals and to perform the channel estimation with high accuracy. In the present embodiment, a method will be described for enabling separation on the receiver by orthogonalizing reference signals and performing channel estimation with high accuracy even in a case that the sequence lengths of reference signals are different from each other between CP-OFDM and DFT-S-OFDM.

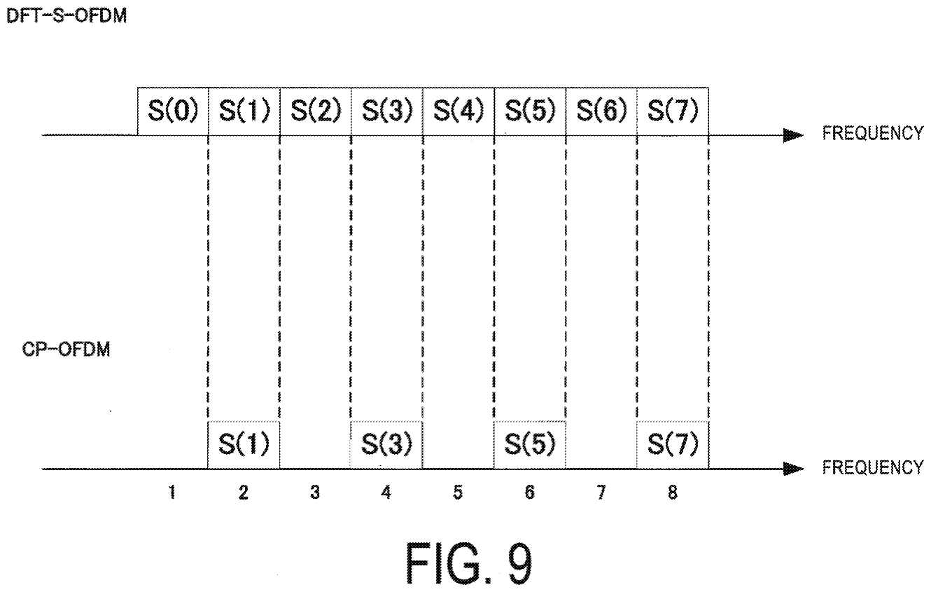

FIG. 9 illustrates an example of a reference signal sequence of DFT-S-OFDM and a reference signal sequence of CP-OFDM generated by the reference signal generation unit 212 in FIG. 2. In this example, the number of subcarriers used in FIG. 9 is eight, and DFT-S-OFDM uses all subcarriers, while CP-OFDM only uses four subcarriers. However, although the reference signals are allocated only in an even number index, the present invention is not limited thereto, and reference signals may be allocated in an odd number, or data signals may be allocated in an even subcarrier rather than a null subcarrier. S(k) in FIG. 9 represents the complex amplitude of the reference signal at k-th frequency index. As can be seen from the drawing, in a case that a reference signal is transmitted at a frequency index in both DFT-S-OFDM and CP-OFDM, the same signal is transmitted. However, completely identical signals cannot be separated by the receiver so that different codes are multiplied for each reference signal. That is, by providing a phase rotation amount proportional to the subcarrier index, channel estimation can be performed by the receiver. For example, by configuring S(1), −S(3), S(5), and −S(7), channel estimation can be performed by adding or subtracting the received signals at the second and fourth subcarriers. Note that the signal provided with a phase rotation amount is not limited to the above only, and channel estimation may be performed by configuring S(1), jS(3), −S(5), and −jS(7), providing the inverse phase rotation to the 2nd, 4th, 6th, 8th subcarriers on the receiver side, and combining the four subcarriers.

Next, a specific sequence will be described. The sequence of S(0) to S(7) in FIG. 9 preferably has a low PAPR. For example, a Zadoff-Chu (ZC) sequence or the like may be considered. In the case of DFT-S-OFDM, a sequence with low PAPR may be generated by using in continuous subcarriers (e.g., frequency indexes 1 to 8). On the other hand, in the case of CP-OFDM, a low PAPR is not required, so at the expense of PAPR, the reference signal is allocated so as to maintain the orthogonality with the reference signal used by DFT-S-OFDM. Note that although CDMA (cyclic shift) is used as an example of the method for orthogonalizing the reference signals above, the present invention is not limited thereto, and a configuration in which multiple OFDM symbols are used and separated by orthogonal cover code (OCC) may be used.

In the case that the number of subcarriers constituting the reference signals in DFT-S-OFDM and CP-OFDM is different and the same subcarrier (RE) is used, the reference signal is generated so as to transmit the same reference signal (root sequence) for the same subcarrier. However, the reference signals can be separated at the receiver, for example, by applying different cyclic shifts for each of the terminal apparatuses or the streams (layers). Thus, a high accuracy channel estimation can be achieved.

A program running on an apparatus according to one aspect of the present invention may serve as a program that controls a Central Processing Unit (CPU) and the like to cause a computer to operate in such a manner as to realize the functions of the above-described embodiment according to one aspect of the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Moreover, the apparatuses in the above-described embodiment may be partially enabled by a computer. In that case, a program for realizing the functions of the embodiments may be recorded in a computer readable recording medium. The functions may be realized by causing a computer system to read the program recorded in the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, each functional block or various characteristics of the apparatuses used in the above-described embodiment may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may be constituted of a digital circuit or an analog circuit. Furthermore, in a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

An aspect of the present invention can be suitably used in a base station apparatus, a terminal apparatus, and a communication method. An aspect of the present invention can be utilized, for example, in a communication system, communication equipment (for example, a cellular phone apparatus, a base station apparatus, a radio LAN apparatus, or a sensor device), an integrated circuit (for example, a communication chip), or a program.

### REFERENCE SIGNS LIST

101 Base station apparatus
102-A, 102-B Terminal apparatus
200-1, 200-2 Coding unit
201-1, 201-2 Scrambling unit
202-1, 202-2 Modulation unit
203 Layer mapping unit
204-1, 204-2 Transform precoding unit
205 Precoding unit
206-1, 206-2 Resource element mapping unit
207-1, 207-2 Signal generation unit
208-1, 208-2 Transmit antenna
209 MCS configuration unit
210 Transmission scheme configuration unit
211 TBS index acquisition unit
212 Reference signal generation unit
213 Control information acquisition unit
214 Receiver
215 Receive antenna
701-1, 701-2 Receive antenna
702-1, 702-2 Signal receiving unit
703-1, 703-2 Resource element demapping unit
704 Channel compensation unit
705-1, 705-2 IDFT unit
706 Layer demapping unit
707-1, 707-2 Demodulation unit
708-1, 708-2 Descrambling unit
709 Channel estimation unit
710 Transmission scheme acquisition unit
711-1, 711-2 Decoding unit

1-7. (canceled)

8. A terminal apparatus comprising:
a reception unit configured to receive a first information associated with waveform via higher layer signaling and a second information associated with DMRS via downlink control information,
a transmission unit configured to transmit the DMRS and physical uplink shared channel,
the transmission unit transmits the DMRS and the uplink data by a same OFDM symbol based on at least the first information and the second information.

9. The terminal apparatus according to claim 8, wherein
the transmission unit transmits the DMRS, the uplink data, and null subcarriers by a same OFDM symbol based on at least the first information and the second information.

10. The terminal apparatus according to claim 8, wherein
the transmission unit transmits the DMRS and the uplink data by a same OFDM symbol when the the first information indicates a waveform is CP-OFDM.

11. The terminal apparatus according to claim 8, wherein
the transmission unit transmits the DMRS, the uplink data, and null subcarriers by a same OFDM symbol when the the first information indicates a waveform is CP-OFDM, and transmits the DMRS and null subcarriers by a same OFDM symbol when the the first information indicates a waveform is DFT-S-OFDM.

12. A base station apparatus comprising:
a transmission unit, configured to transmit a first information associated with waveform via higher layer signaling and a second information associated with DMRS via downlink control information,
a reception unit configured to receive the DMRS and physical uplink shared channel,
the reception unit receives the DMRS and the uplink data by a same OFDM symbol based on at least the first information and the second information.

13. The base station apparatus according to claim 12, wherein
the reception unit receives the DMRS, the uplink data, and null subcarriers by a same OFDM symbol based on at least the first information and the second information.

14. The base station apparatus according to claim 12, wherein
the reception unit receives the DMRS and the uplink data by a same OFDM symbol when the the first information indicates a waveform is CP-OFDM.

15. The base station apparatus according to claim 8, wherein
the reception unit receives the DMRS, the uplink data, and null subcarriers by a same OFDM symbol when the the first information indicates a waveform is CP-OFDM, and receives the DMRS and null subcarriers by a same OFDM symbol when the the first information indicates a waveform is DFT-S-OFDM.
